(19) United States
(12) Patent Application Publication
(10) Pub. No.: US 2005/0011319 A1
(43) Pub. Date: Jan. 20, 2005

(54) Sleeve device

(76) Inventor: Yao-Lin Cho, Taichung (TW)

Correspondence Address: Yao-Lin Cho, 58, MA YUAN WEST ST., TAICHUNG, TW

(21) Appl. No.: 10/620,975

(22) Filed: Jul. 14, 2003

(51) Int. Cl. B25B 23/16

(52) U.S. Cl. 81/177.85

(57) ABSTRACT

A sleeve device has a main body and a retainer device. The main body has a first end portion having a hollow interior and a through hole communicating with the hollow interior, and a second end portion. A diameter of the first end portion is smaller than a diameter of the second end portion. A diameter of the first end portion is slightly smaller than a diameter of the retainer device. The retainer device is inserted in the first end portion of the main body. The retainer device has a through aperture to match the through hole of the main body. A steel ball is inserted through the through aperture of the retainer device and the through hole of the main body.

### BACKGROUND OF THE INVENTION

The present invention relates to a sleeve device. More particularly, the present invention relates to a sleeve device which is often engaged with a spanner.

A conventional sleeve device cannot be engaged with a normal spanner stably. A box end of a special spanner should be modified in order to receive the conventional sleeve device stably.

### SUMMARY OF THE INVENTION

An object of the present invention is to provide a sleeve device which is easily engaged with a normal spanner stably.

Accordingly, a sleeve device comprises a main body and a retainer device. The main body has a first end portion having a hollow interior and a through hole communicating with the hollow interior, and a second end portion. A diameter of the first end portion is slightly smaller than a diameter of the retainer device. The retainer device is inserted in the first end portion of the main body. The retainer device has an elastic element having an outer protruded portion inserted through the through hole of the main body.

### BRIEF DESCRIPTION OF THE DRAWINGS

FIG. 1 is a perspective exploded view of a sleeve device of a first preferred embodiment in accordance with the present invention;

FIG. 2 is a perspective assembly view of a sleeve device of a first preferred embodiment in accordance with the present invention;

FIG. 3 is a sectional assembly view of a sleeve device of a first preferred embodiment in accordance with the present invention;

FIG. 4 is a sectional view taken along line 5-5 in FIG. 3;

FIG. 5 is a schematic view illustrating a ratchet box end of a spanner engaging with a sleeve device of a first preferred embodiment in accordance with the present invention;

FIG. 6 is a schematic view illustrating an open end of a spanner engaging with a sleeve device of a first preferred embodiment in accordance with the present invention;

FIG. 7 is a schematic view illustrating an application of a sleeve device of a first preferred embodiment in accordance with the present invention;

FIG. 8 is a perspective exploded view of a sleeve device of a second preferred embodiment in accordance with the present invention;

FIG. 9 is a sectional assembly view of a sleeve device of a second preferred embodiment in accordance with the present invention;

FIG. 10 is a perspective exploded view of a sleeve device of a third preferred embodiment in accordance with the present invention;

FIG. 11 is a sectional assembly view of a sleeve device of a third preferred embodiment in accordance with the present invention; and

FIG. 12 is a sectional view taken along line 6-6 in FIG. 11.

### DETAILED DESCRIPTION OF THE INVENTION

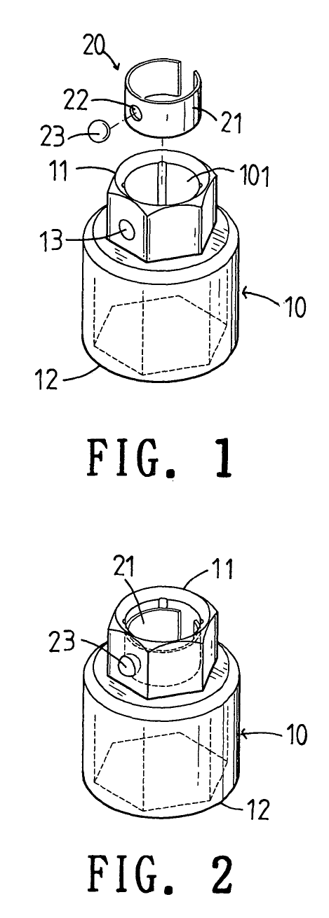

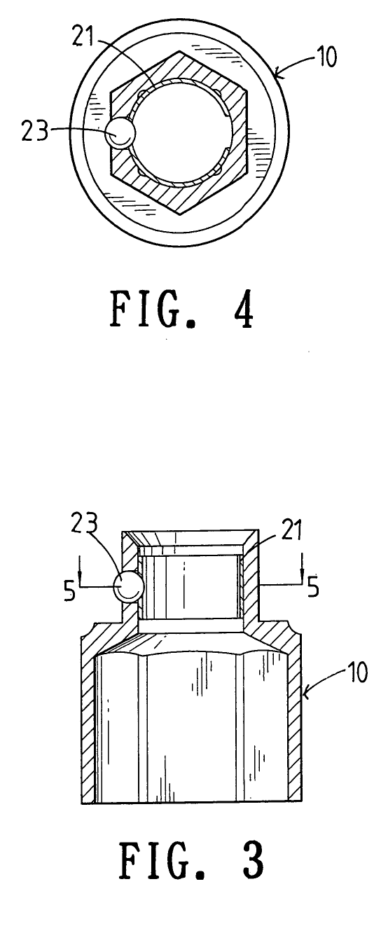

Referring to FIGS. 1 to 4, a first sleeve device comprises a main body 10 and a retainer device 20.

The main body 10 has a first end portion 11 having a hollow interior 101 and a through hole 13 communicating with the hollow interior 101, and a second end portion 12.

A diameter of the first end portion 11 is smaller than a diameter of the second end portion 12.

A diameter of the first end portion 11 is slightly smaller than a diameter of the retainer device 20.

The retainer device 20 is inserted in the first end portion 11 of the main body 10.

The retainer device 20 has a C-shaped elastic element 21 having a through aperture 22 to match the through hole 13 of the main body 10.

A steel ball 23 is inserted through the through aperture 22 of the retainer device 20 and the through hole 13 of the main body 10.

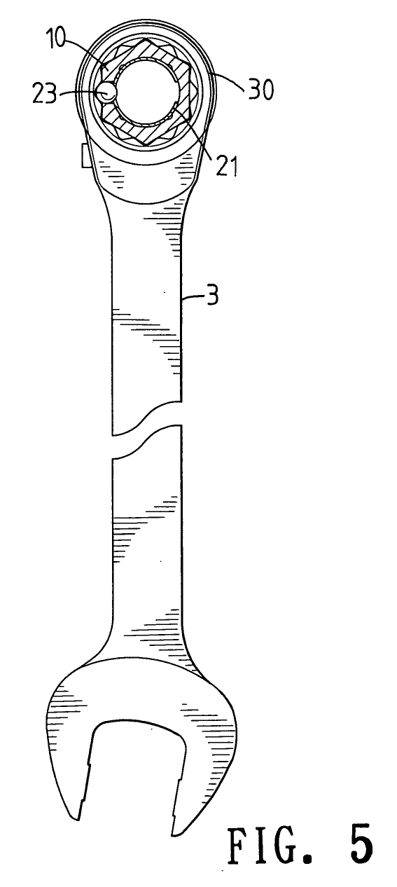

FIG. 5 is a schematic view illustrating a ratchet box end 30 of a spanner 3 engaging with the sleeve device. When the box end 30 of the spanner 3 engages with the first sleeve device, the steel ball 23 will block an inner surface of the box end 30 of the spanner 3. The elastic element 21 will push the steel ball 23 to move toward the inner surface of the box end 30 of the spanner 3.

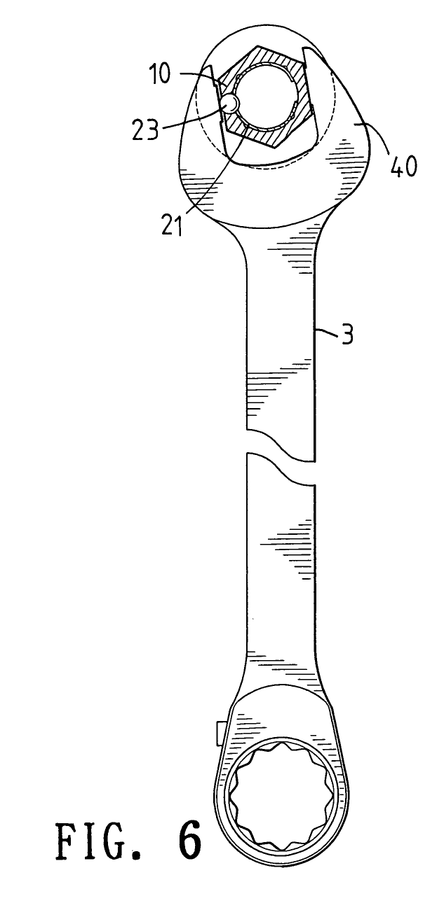

FIG. 6 is a schematic view illustrating an open end 40 of the spanner 3 engaging with the sleeve device. The steel ball 23 will block an inner surface of the open end 40 of the spanner 3.

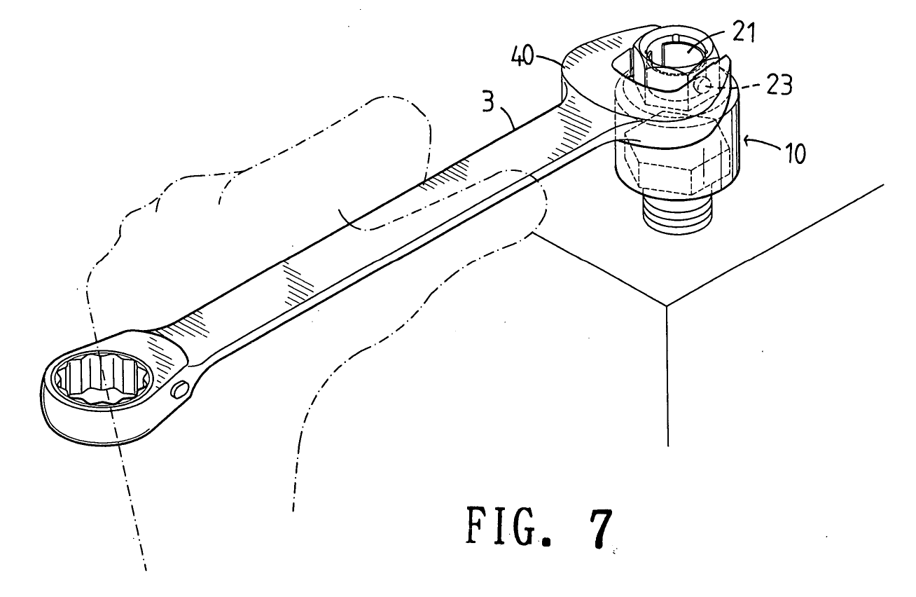

FIG. 7 is a schematic view illustrating the sleeve device engaging with a hexagonal nut.

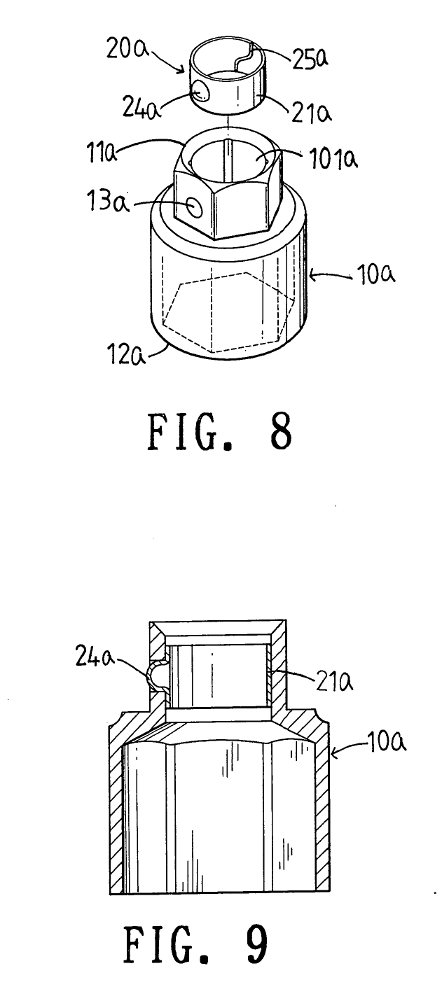

Referring to FIGS. 8 and 9, a second sleeve device comprises a main body 10a and a retainer device 20a.

The main body 10a has a first end portion 11a having a hollow interior 101a and a through hole 13a communicating with the hollow interior 110a, and a second end portion 12a.

A diameter of the first end portion 11a is smaller than a diameter of the second end portion 12a.

A diameter of the first end portion 11a is slightly smaller than a diameter of the retainer device 20a.

The retainer device 20a is inserted in the first and portion 11a of the main body 10a.

The retainer device 20a has an elastic element 21a having an outer protruded portion 24a inserted through the through hole 13a of the main body 10a and a slit 25a.

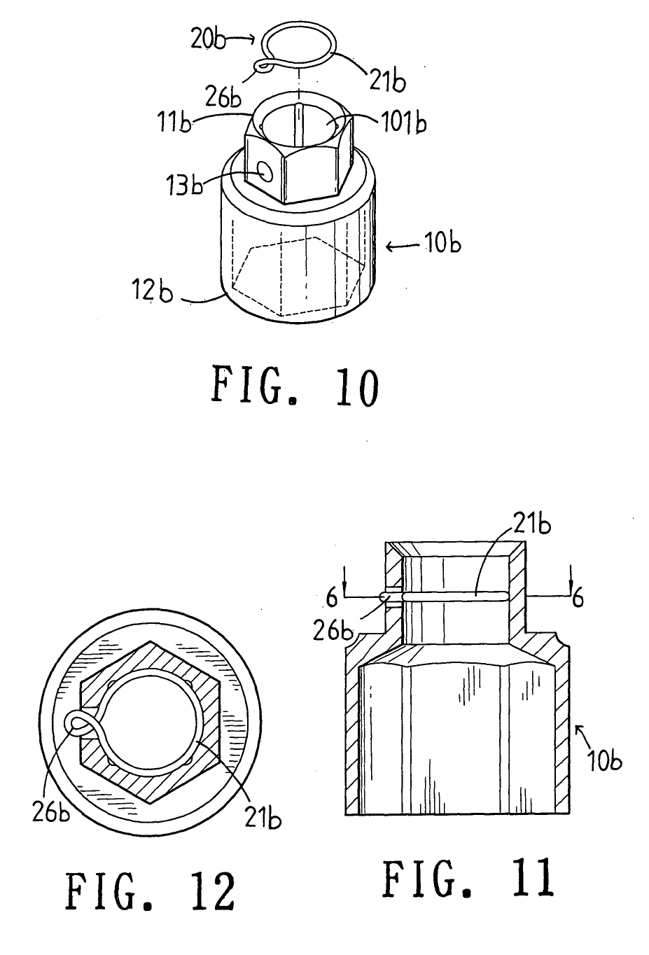

Referring to FIGS. 10 to 12, a third sleeve device comprises a main body 10b and a retainer device 20b.

The main body 10b has a first end portion 11b having a hollow interior 101b and a through hole 13b communicating with the hollow interior 101b, and a second end portion 12b.

A diameter of the first end portion 11b is smaller than a diameter of the second end portion 12b.

A diameter of the first end portion 11b is slightly smaller than a diameter of the retainer device 20b.

The retainer device 20b is inserted in the first end portion 11a of the main body 10b.

The retainer device 20b has a ring-shaped elastic element 21b having a twisted protruded portion 26b inserted through the through hole 13b of the main body 10b.

The sleeve device of the present invention is easily engaged with a box end or an open end of a normal spanner stably.

The present invention is not limited to the above embodiments but various modification thereof may be made. Furthermore, various changes in form and detail may be made without departing from the scope of the present invention.

1. A sleeve device comprises:
a main body and a retainer device,
the main body having a first end portion having a hollow interior and a peripheral wall formed with a through hole communicating with the hollow interior, and a second end portion,
a diameter of the first end portion slightly smaller than a diameter of the retainer device,
the retainer device inserted in the first end portion of the main body, and
the retainer device having an elastic element integrally formed with an outer protruded portion inserted through and protruded outward from the through hole of the main body, wherein
the elastic element has a peripheral wall formed with a slit located radially opposite to the outer protruded portion of the retainer device.

2. The sleeve device as claimed in claim 1, wherein the slit of the elastic element is substantially Z-shaped.

3. The sleeve device as claimed in claim 1, wherein the elastic element has a ring shape.

4. (canceled)

5. The sleeve device as claimed in claim 1, wherein the outer protruded portion of the retainer device has a twisted shape.
